(19) United States
(12) Patent Application Publication
(10) Pub. No.: US 2026/0066730 A1
(43) Pub. Date: Mar. 5, 2026

(54) STATOR OF AXIAL GAP MOTOR

(71) Applicant: SHINANO KENSHI CO., LTD., Ueda-shi (JP)

(72) Inventor: Koichi ICHIKI, Nagano (JP)

(73) Assignee: SHINANO KENSHI CO., LTD., Ueda-shi (JP)

(21) Appl. No.: 19/292,206

(22) Filed: Aug. 6, 2025

(30) Foreign Application Priority Data
Sep. 2, 2024 (JP) 2024-150888

(51) Int. Cl. H02K 3/26; H02K 21/24

(52) U.S. Cl. CPC H02K 3/26; H02K 21/24; H02K 2203/03

(57) ABSTRACT

A stator, of an axial gap motor, includes a printed circuit board having insulating layers including first and second insulating layers, first coil patterns formed of conductor patterns in the first insulating layer, and second coil patterns formed of conductor patterns in the second insulating layer.

### CROSS-REFERENCE TO RELATED APPLICATION

This application is based upon and claims the benefit of priority of the prior Japanese Patent Application No. 2024-150888, filed on Sep. 2, 2024, the entire contents of which are incorporated herein by reference.

### BACKGROUND

### (i) Technical Field

The present disclosure relates to a stator of an axial gap motor.

### (ii) Related Art

A stator of an axial gap motor includes a substrate and coils disposed on the substrate (for example, see Japanese Utility Model Application Publication No. Sho 59-013082).

For example, when an impact is applied to the stator of such an axial gap motor, the position of the coil might be shifted with respect to the substrate. Such a positional deviation might change the output characteristics of the axial gap motor.

### SUMMARY

According to an aspect of the present disclosure, there is provided a stator, of an axial gap motor, including: a printed circuit board having insulating layers including first and second insulating layers; first coil patterns formed of conductor patterns in the first insulating layer; and second coil patterns formed of conductor patterns in the second insulating layer.

### BRIEF DESCRIPTION OF THE DRAWINGS

FIG. 1 is a cross-sectional view of an axial gap motor;

FIG. 2 is a front view of a printed circuit board;

FIG. 3 is a front view of the printed circuit board;

FIG. 4 is a sectional view taken along line A-A of FIG. 2;

FIG. 5 is a sectional view taken along line B-B of FIG. 2; and

FIG. 6 is a cross-sectional view of a printed circuit board in a variation.

### DETAILED DESCRIPTION

[Schematic Configuration of Axial Gap Motor]

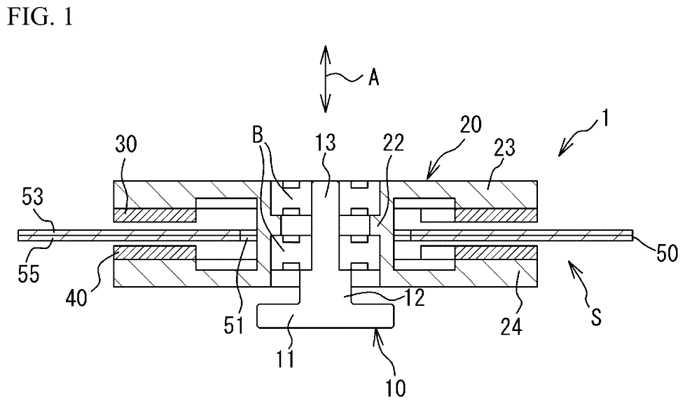

FIG. 1 is a cross-sectional view of an axial gap motor 1. FIG. 1 schematically illustrates the axial gap motor 1. The axial gap motor 1 includes a support shaft 10, a yoke 20, magnetic pole portions 30 and 40, and a stator S. The support shaft 10 rotatably supports the yoke 20. The yoke 20 and the magnetic pole portions 30 and 40 correspond to a rotor. The support shaft 10 includes a flange portion 11, a step portion 12, and a thin shaft portion 13. The step portion 12 has a smaller diameter than the flange portion 11. The thin shaft portion 13 has a smaller diameter than the step portion 12. Two bearings B are held by the thin shaft portion 13. The yoke 20 includes a cylindrical portion 22 and flange portions 23 and 24. The flange portions 23 and 24 are each in a flange shape. The flange portions 23 and 24 are separated from each other in an axial direction A. The stator S includes a printed circuit board 50. The printed circuit board 50 is a multilayer board, which will be described in detail later, and has a plurality of coil patterns formed therein. The stator S is disposed between the flange portions 23 and 24. An opening 51 for allowing the support shaft 10 to escape is formed in the center of the printed circuit board 50.

The magnetic pole portion 30 is provided on a surface of the flange portion 23 facing the stator S. The magnetic pole portion 40 is provided on a surface of the flange portion 24 facing the stator S. Each of the magnetic pole portions 30 and 40 is an annular permanent magnet. The surfaces of the magnetic pole portions 30 and 40 facing the stator S are magnetized to have polarities alternately different in the circumferential direction. In the present embodiment, each of the magnetic pole portions 30 and 40 has eight poles in the circumferential direction. Each of the magnetic pole portions 30 and 40 may be a plurality of permanent magnets arranged in the circumferential direction. In this case, the surfaces of the plurality of permanent magnets facing the stator S are also magnetized to have polarities alternately different in the circumferential direction.

The plurality of coil patterns formed inside the printed circuit board 50 face the magnetic pole portions 30 and 40 in the axial direction A with a gap therebetween. By controlling the energization state of the plurality of coil patterns, the yoke 20 rotates with respect to the support shaft 10 in accordance with the magnetic force generated between the plurality of coil patterns and the magnetic pole portion 30 and between the plurality of coil patterns and the magnetic pole portion 40. The stator S is held at its outer peripheral end by a holder (not illustrated), and is not rotatable relative to the yoke 20.

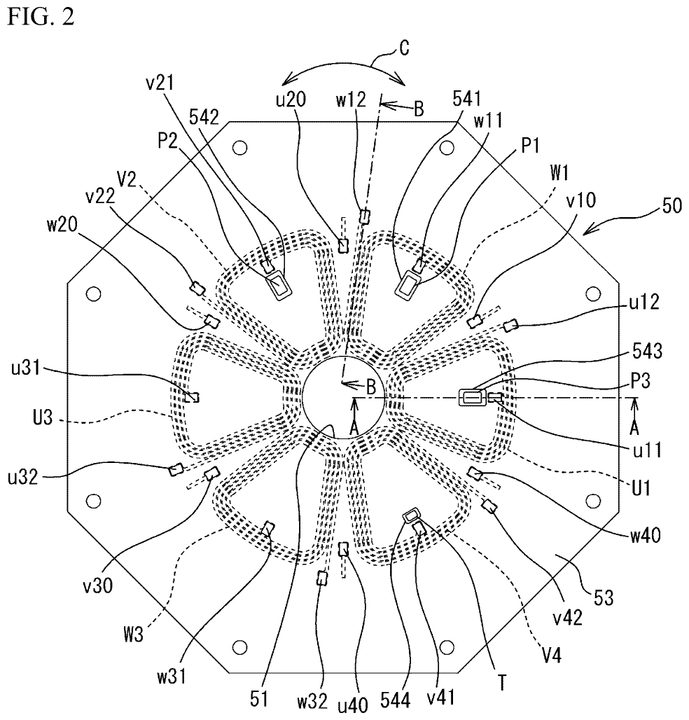

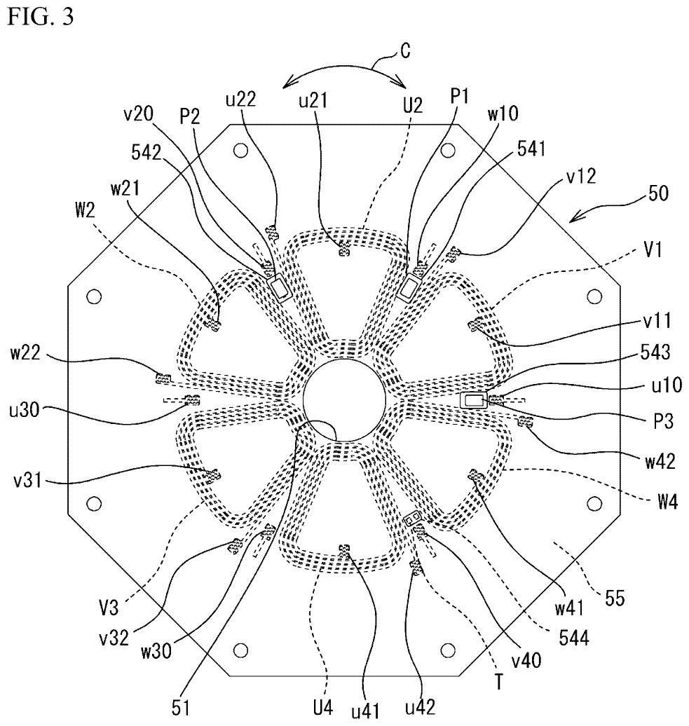

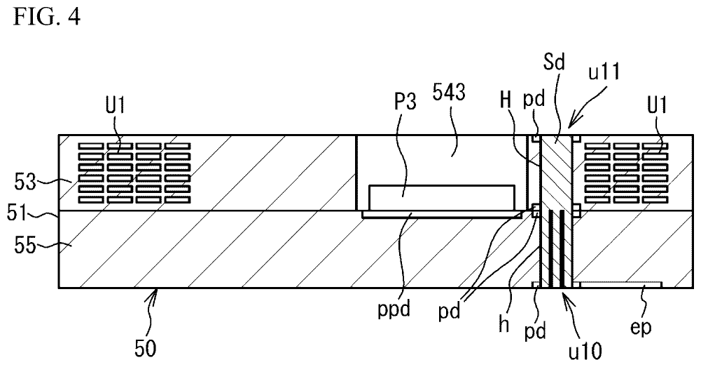

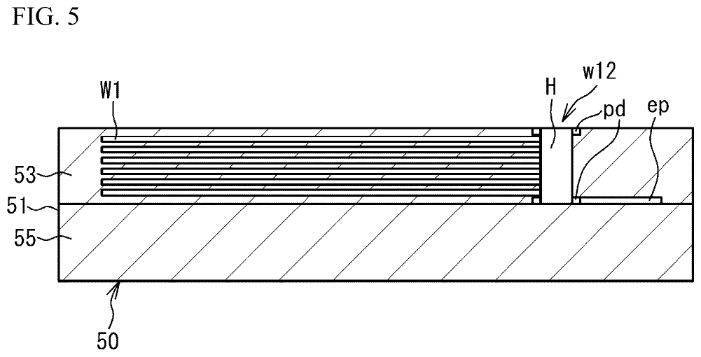

FIGS. 2 and 3 are front views of the printed circuit board 50. The printed circuit board 50 includes a first insulating layer 53 and a second insulating layer 55 mainly made of resin. The first insulating layer 53 and the second insulating layer 55 have electrical insulating properties. The first insulating layer 53 and the second insulating layer 55 are formed by, for example, impregnating a glass woven fabric (glass cloth) or a glass nonwoven fabric with an insulating epoxy resin, phenol resin, polyimide resin, BT resin, or the like and curing the resin. FIG. 2 illustrates coil patterns U1, W1, V2, U3, W3, and V4 formed in the first insulating layer 53 of the printed circuit board 50 by dotted lines. FIG. 3 illustrates coil patterns V1, U2, W2, V3, U4, and W4 formed in the second insulating layer 55 of the printed circuit board 50 by dotted lines. In FIG. 2, for easy understanding, the coil patterns V1, U2, W2, V3, U4, and W4 formed in the second insulating layer 55 are not illustrated. In FIG. 3, for easy understanding, the coil patterns U1, W1, V2, U3, W3, and V4 formed in the first insulating layer 53 are not illustrated. FIG. 4 is a cross-sectional view taken along line A-A of FIG. 2. FIG. 5 is a sectional view taken along line B-B of FIG. 2. The first insulating layer 53 faces the magnetic pole portion 30, and the second insulating layer 55 faces the magnetic pole portion 40. Note that a signal pattern, a power supply pattern, a ground pattern, and the like (not illustrated) are formed in the first insulating layer 53 and the second insulating layer 55.

The printed circuit board 50 is provided with coil-shaped coil patterns U1 to U4, V1 to V4, and W1 to W4 formed of conductive patterns. To be specific, as illustrated in FIG. 2, the coil patterns U1, W1, V2, U3, W3, and V4 are formed in the first insulating layer 53 at intervals of 60 degrees in a circumferential direction C. The coil patterns U1, W1, V2, U3, W3, and V4 are examples of a first coil pattern. As illustrated in FIG. 3, the coil patterns V1, U2, W2, V3, U4, and W4 are formed in the second insulating layer 55 at intervals of 60 degrees in the circumferential direction C. The coil patterns V1, U2, W2, V3, U4, and W4 are examples of a second coil pattern. That is, the U-phase coil patterns U1 to U4, the V-phase coil patterns V1 to V4, and the W-phase coil patterns W1 to W4 are formed in the printed circuit board 50. The coil patterns U1 to U4 are conductively connected to each other in the printed circuit board 50. The same applies to the coil patterns V1 to V4 and the coil patterns W1 to W4. The coil patterns U1 to U4 are formed by distributed winding. The same applies to the coil patterns V1 to V4 and W1 to W4.

Each coil pattern is formed by a conductor pattern that is wound in a coil shape approximately four times on the same plane. In other words, the number of turns of each coil pattern is approximately four, but is not limited thereto. As illustrated in FIGS. 4 and 5, the six coil-shaped conductor patterns are spaced apart from each other and overlap each other in the thickness direction of the printed circuit board 50, that is, in the axial direction A. The number of the coil-shaped conductor patterns is not limited to six, and may be one or more.

The coil patterns U1, V1, W1, U2, V2, W2, U3, V3, W3, U4, V4, and W4 are arranged in the circumferential direction C (counterclockwise in FIGS. 2 and 3). The coil patterns U1 to U4 are set at intervals of 90 degrees in the circumferential direction C. The coil patterns V1 to V4 are set at intervals of 90 degrees in the circumferential direction C. The coil patterns W1 to W4 are set at intervals of 90 degrees in the circumferential direction C. The number of coil patterns formed in the first insulating layer 53 and the number of coil patterns formed in the second insulating layer 55 are the same, i.e., six.

As illustrated in FIGS. 2 and 3, the coil patterns U1 to U4, V1 to V4, and W1 to W4 are formed in the printed circuit board 50. Therefore, for example, even when an impact is applied to the printed circuit board 50, the positions of the coil patterns U1 to U4, V1 to V4, and W1 to W4 are prevented from being shifted with respect to the printed circuit board 50.

Therefore, the stator S has improved impact resistance. The coil patterns U1 to U4, V1 to V4, and W1 to W4 are formed within the thickness of the printed circuit board 50. Therefore, the stator S in the present embodiment is made thinner than a stator in which a plurality of coils are set on a printed circuit board.

As illustrated in FIGS. 2 and 3, the coil pattern U1 is partially overlapped with the coil patterns W4 and V1 in the axial direction A and is separated therefrom in the axial direction A. The coil pattern W1 is partially overlapped with the coil patterns V1 and U2 in the axial direction A and is separated therefrom in the axial direction A. The coil pattern V2 is partially overlapped with the coil patterns U2 and W2 in the axial direction A and is separated therefrom in the axial direction A. The coil pattern U3 is partially overlapped with the coil patterns W2 and V3 in the axial direction A and is separated therefrom in the axial direction A. The coil pattern W3 is partially overlapped with the coil patterns V3 and U4 in the axial direction A and is separated therefrom in the axial direction A. The coil pattern V4 is partially overlapped with the coil patterns U4 and W4 in the axial direction A and is separated therefrom in the axial direction A. The coil pattern V1 is partially overlapped with the coil patterns U1 and W1 in the axial direction A and is separated therefrom in the axial direction A. The coil pattern U2 is partially overlapped with the coil patterns W1 and V2 in the axial direction A and is separated therefrom in the axial direction A. The coil pattern W2 is partially overlapped with the coil patterns V2 and U3 in the axial direction A and is separated therefrom in the axial direction A. The coil pattern V3 is partially overlapped with the coil patterns U3 and W3 in the axial direction A and is separated therefrom in the axial direction A. The coil pattern U4 is partially overlapped with the coil patterns W3 and V4 in the axial direction A and is separated therefrom in the axial direction A. The coil pattern W4 is partially overlapped with the coil patterns V4 and U1 in the axial direction A and is separated therefrom in the axial direction A. Thus, a large number of coil patterns are formed in the circumferential direction C while suppressing an increase in the thickness of the printed circuit board 50.

As illustrated in FIG. 2, position sensors P1, P2, and P3 are surrounded by the coil patterns W1, V2, and U1, respectively, and are provided in the first insulating layer 53 of the printed circuit board 50. A temperature sensor T is surrounded by the coil pattern V4 and provided in the first insulating layer 53 of the printed circuit board 50. In detail, holes 541, 542, 543, and 544 surrounded by the coil patterns W1, V2, U1, and V4, respectively, are formed in the first insulating layer 53. The position sensors P1, P2, and

P3 are located in the holes 541, 542, and 543, respectively, and are mounted on an end surface, of the second insulating layer 55, which is a boundary surface between the first insulating layer 53 and the second insulating layer 55. Similarly, the temperature sensor T is located in the hole 544 and is mounted on the end surface, of the second insulating layer 55, which is the boundary surface between the first insulating layer 53 and the second insulating layer 55. In this way, the position sensors P1 to P3 and the temperature sensor T are prevented from interfering with the coil patterns W1, V2, U1, and V4, respectively. As a result, the installation areas of the coil patterns U1 to U4, V1 to V4, and W1 to W4 are secured. Note that the position sensors P1 to P3 are Hall elements.

FIG. 3 illustrates the mounting positions of the position sensors P1 to P3 and the temperature sensor T on the end surface of the second insulating layer 55. As illustrated in FIG. 3, the position sensor P1 is disposed between the coil patterns V1 and

U2 adjacent to each other in the circumferential direction C. The position sensor P2 is disposed between the coil patterns U2 and W2 adjacent to each other in the circumferential direction C. The position sensor P3 is disposed between the coil patterns W4 and

V1 adjacent to each other in the circumferential direction C. The temperature sensor T are installed between the coil patterns U4 and W4 adjacent to each other in the circumferential direction C. In this way, the position sensors P1 to P3 and the temperature sensor T are provided at positions that do not overlap any of the coil patterns U1 to U4, V1 to V4, and W1 to W4 in the axial direction A. This suppresses the influence of the energization of the coil patterns U1 to U4, V1 to V4, and W1 to W4 on the detection accuracy of the position sensors P1 to P3 and the temperature sensor T.

The details of the conductive connection of the coil patterns U1 to U4, V1 to V4, and W1 to W4 will be described. As illustrated in FIG. 2, connecting portions u11 and u12 formed in the first insulating layer 53 are conductively connected to one end and the other end of the coil pattern U1, respectively. The connecting portion u11 is located inside to be surrounded by the coil pattern U1. The connecting portion u12 is located outside the coil pattern U1. Similarly, one end and the other end of the coil pattern W1, one end and the other end of the coil pattern V2, one end and the other end of the coil pattern U3, one end and the other end of the coil pattern W3, and one end and the other end of the coil pattern V4 are respectively and conductively connected to connecting portions w11 and w12, v21 and V22, u31 and u32, w31 and w32, and v41 and v42 formed in the first insulating layer 53.

Similarly, as illustrated in FIG. 3, one end and the other end of the coil pattern V1, one end and the other end of the coil pattern U2, one end and the other end of the coil pattern W2, one end and the other end of the coil pattern V3, one end and the other end of the coil pattern U4, and one end and the other end of the coil pattern W4 are respectively and conductively connected to connecting portions v11 and v12, u21 and u22, w21 and w22, v31 and v32, u41 and u42, and w41 and w42 formed in the second insulating layer 55.

As illustrated in FIG. 2, a connecting portion v10 is formed between the coil patterns U1 and W1 in the first insulating layer 53. Similarly, connecting portions u20, w20, v30, u40, and w40 are respectively formed between the coil patterns W1 and V2, between the coil patterns V2 and U3, between the coil patterns U3 and W3, between the coil patterns W3 and V4, and between the coil patterns V4 and U1 in the first insulating layer 53. The connecting portions v10, u20, w20, v30, u40, and w40 are conductively connected to the connecting portions v11, u21, W21, v31, u41, and w41 formed in the second insulating layer 55, respectively.

As illustrated in FIG. 3, in the second insulating layer 55, connecting portions u10, w10, v20, u30, w30, and v40 are formed between the coil patterns W4 and V1, between the coil patterns V1 and U2, between the coil patterns U2 and W2, between the coil patterns W2 and V3, between the coil patterns V3 and U4, and between the coil patterns U4 and W4, respectively. The connecting portions u10, w10, v20, u30, w30, and v40 are electrically connected to the connecting portions u11, w11, v21, u31, w31, and v41 formed in the first insulating layer 53, respectively.

The connecting portion v40 formed in the second insulating layer 55 is connected to a power supplying pattern ep (not illustrated) and is energized. The connecting portion v40 is electrically connected to the connecting portion v41, the coil pattern V4, and the connecting portion v42 formed in the first insulating layer 53. The connecting portion v42 is electrically connected to the connecting portion v10 via a pattern (not illustrated) formed in the first insulating layer 53. The connecting portion v10 is electrically connected to the connecting portion v11, the coil pattern V1, and the connecting portion v12 formed in the second insulating layer 55. The connecting portion v12 is electrically connected to the connecting portion v20 via a pattern (not illustrated) formed in the second insulating layer 55. The connecting portion v20 is electrically connected to the connecting portion v21, the coil pattern V2, and the connecting portion v22 formed in the first insulating layer 53. The connecting portion v22 is electrically connected to the connecting portion v30 via a pattern (not illustrated) formed in the first insulating layer 53. The connecting portion v30 is electrically connected to the connecting portion v31, the coil pattern V3, and the connecting portion v32 formed in the second insulating layer 55. The connecting portion v32 is electrically connected to the connecting portions w22 and u42 via a pattern (not illustrated) formed in the second insulating layer 55.

The connecting portion u10 formed in the second insulating layer 55 is connected to the power supplying pattern ep (not illustrated) and is energized. The connecting portion u10 is electrically connected to the connecting portion u11, the coil pattern U1, and the connecting portion u12 formed in the first insulating layer 53. The connecting portion u12 is electrically connected to the connecting portion u20 via a pattern (not illustrated) formed in the first insulating layer 53. The connecting portion u20 is electrically connected to the connecting portion u21, the coil pattern U2, and the connecting portion u22 formed in the second insulating layer 55. The connecting portion u22 is electrically connected to the connecting portion u30 via a pattern (not illustrated) formed in the second insulating layer 55. The connecting portion u30 is electrically connected to the connecting portion u31, the coil pattern U3, and the connecting portion u32 formed in the second insulating layer 55. The connecting portion u32 is electrically connected to the connecting portion u40 via a pattern (not illustrated) formed in the first insulating layer 53. The connecting portion u40 is electrically connected to the connecting portion u41, the coil pattern U4, and the connecting portion u42 formed in the second insulating layer 55. The connecting portion u42 is electrically connected to the connecting portions v32 and w22 via a pattern (not illustrated) formed in the second insulating layer 55.

The connecting portion w30 formed in the second insulating layer 55 is connected to the power supplying pattern ep (not illustrated) and is energized. The connecting portion w30 is electrically connected to the connecting portion w31, the coil pattern W3, and the connecting portion w32 formed in the first insulating layer 53. The connecting portion w32 is electrically connected to the connecting portion w40 via a pattern (not illustrated) formed in the second insulating layer 55. The connecting portion w40 is electrically connected to the connecting portion w41, the coil pattern W4, and the connecting portion w42 formed in the second insulating layer 55. The connecting portion w42 is electrically connected to the connecting portion w10 via a pattern (not illustrated) formed in the second insulating layer 55. The connecting portion w10 is electrically connected to the connecting portion w11, the coil pattern W1, and the connecting portion w12 formed in the first insulating layer 53. The connecting portion w12 is electrically connected to the connecting portion w20 via a pattern (not illustrated) formed in the first insulating layer 53. The connecting portion w20 is electrically connected to the connecting portion w21, the coil pattern W2, and the connecting portion w22 formed in the second insulating layer 55. The connecting portion w22 is electrically connected to the connecting portions v32 and u42 via a pattern (not illustrated) formed in the second insulating layer 55. A pattern connecting the connecting portions w22, v32, and u42 corresponds to a neutral point.

As illustrated in FIG. 4, the position sensor P3 surrounded by the coil pattern U1 does not protrude from an end surface of the first insulating layer 53 on the side opposite to the second insulating layer 55. That is, the position sensor P3 is disposed within the first insulating layer 53. The same applies to the position sensors P1 and P2 and the temperature sensor T. The coil patterns U1, W1, V2, U3, W3, and V4 are provided in the first insulating layer 53, and the coil patterns V1, U2, W2, V3, U4, and W4 are provided in the second insulating layer 55. Therefore, the stator S is made thinner.

As illustrated in FIG. 4, the position sensor P3 is electrically connected to a pad ppd provided on the upper surface of the second insulating layer 55. That is, the hole 543 in which the position sensor P3 is disposed is formed to penetrate the first insulating layer 53. The same applies to the other holes 541 and 542. For example, unlike the present embodiment, the first insulating layer 53 and the second insulating layer 55 may not be separately manufactured, and the first insulating layer 53 and the second insulating layer 55 may be formed as a single insulating layer. It is conceivable to provide a non-penetrating hole in the insulating layer and to arrange the position sensor in the hole. In this case, it is needed to form the hole in the printed circuit board to the depth position of the pad ppd electrically connected to the position sensor, and if the hole deeper than the depth of the pad ppd is formed, the pad ppd might be damaged. On the contrary, if the hole shallower than the depth of the pad ppd is formed, the pad ppd is buried in the insulating layer, which is expected to cause a connection failure. A manufacturing method that achieves such high precision might be difficult. On the other hand, in the present embodiment, the first insulating layer 53 and the second insulating layer 55 may be manufactured separately, and the holes 541 to 543 may be formed by processing the first insulating layer 53. Therefore, the printed circuit board 50 is easily manufactured.

As illustrated in FIG. 4, the connecting portion u11 includes a through hole H penetrating the first insulating layer 53, and pads pd electrically connected to the through hole H and provided on the upper surface and the bottom surface of the first insulating layer 53. In this embodiment, the term “pad” is used, but a land may be used. The connecting portion u10 includes a plurality of through holes h penetrating the second insulating layer 55 and pads pd electrically connected to the plurality of through holes h and provided on the front and bottom surfaces of the second insulating layer 55. The through hole H and the plurality of through holes h overlap each other in the thickness direction of the printed circuit board 50 and are conductively connected to each other via the plurality of pads pd. The inner diameter of the through hole H is larger than the inner diameter of the through hole h. The through hole H and the plurality of through holes h overlap each other so as to communicate with each other. The through hole H and the plurality of through holes h are filled with a common solder sd. The solder sd is filled from the through hole H in a state where the first insulating layer 53 and the second insulating layer 55 are overlapped with each other, and thus the solder sd flows to the plurality of through holes h. In this way, the connecting portion u11 and the connecting portion u10 are conductively connected to each other via the solder sd. As described above, the through hole H and the plurality of through holes h are conductively connected via the pads pd, but simply bringing the pads pd into contact with each other might not reliable in a situation where an impact is applied. On the other hand, in the present embodiment, by filling the through hole H and the plurality of through holes h with the solder sd, the coil pattern and the like formed in the first insulating layer 53 are easily conductively connected to the power supply pattern ep and the like formed in the second insulating layer 55 which is another insulating layer, and the insulating layers are firmly connected to each other, and the impact resistance is improved. Further, since the inner diameter of the through hole H is larger than that of the through hole h, it is easy to fill the solder sd from the through hole H.

In addition, the connecting portions v10, u20, w20, v30, u40, w40, u11, w11, v21, u31, w31, and v41 formed in the first insulating layer 53 are respectively and firmly connected to the connecting portions v11, u21, w21, v31, u41, w41, u10, w10, v20, u30, w30, and v40 formed in the second insulating layer 55 by the solder connecting the through hole H and the plurality of through holes h. In FIG. 4, the power supplying pattern ep electrically connected to the pad pd of the connecting portion u10 is illustrated on the bottom surface of the second insulating layer 55.

As illustrated in FIG. 5, the connecting portion w12 includes the through hole H penetrating the first insulating layer 53, and pads pd electrically connected to the through hole H and provided on the front and bottom surfaces of the first insulating layer 53. The through hole H of the connecting portion w12 is not filled with solder. An inner wall of the through hole H is formed of conductive material, and patterns of six layers of the coil pattern W1 are electrically connected to each other. The other connecting portions u12, v22, u32, w32, and v42 formed in the first insulating layer 53 have the same configuration, and are not filled with solder. The other connecting portions u12, v22, u32, w32, and v42 are electrically connected through the pads pd to the power supply pattern ep, a signal pattern (not illustrated), a power pattern, a ground pattern, and the like. Although not illustrated in FIG. 5, an inner wall of the through hole h formed in the second insulating layer 55 is also formed of conductive material, and the connecting portions v12, u22, w22, v32, u42, and w42 have the same configuration as described above and are not filled with solder. The same applies to the conduction to the power supply pattern ep, the signal pattern, the power pattern, the ground pattern, and the like (not illustrated) through the pads pd. In this way, when the coil patterns formed in the respective insulating layers of the first insulating layer 53 or the second insulating layer 55 are conductively connected to each other or the coil pattern and the power supply pattern ep are conductively connected to each other, it is not needed to fill the through hole H or the through hole h with the solder sd, and the coil patterns may be conductively connected to each other only by the through hole H or the through hole h. Therefore, the number of solder filling portions is reduced, and the production cost is reduced.

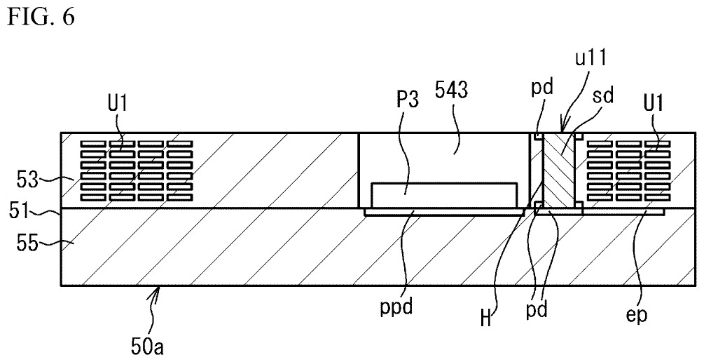

FIG. 6 is a cross-sectional view of a printed circuit board 50a in a variation. FIG. 6 corresponds to FIG. 4. The connecting portion u10 described above is not formed in the second insulating layer 55 of the printed circuit board 50a. The pad pd is formed on the end surface of the second insulating layer 55 and is conductively connected to the pad pd of the connecting portion u11. The pad pd on the end surface of the second insulating layer 55 is conductively connected to the power supply pattern ep, the signal pattern, the power pattern, the ground pattern, and the like (not illustrated) formed on the end surface of the second insulating layer 55. As in the description with reference to FIG. 4, by filling the through hole H with the solder sd, the coil pattern and the like formed in the first insulating layer 53 is easily conductively connected to the power supply pattern ep and the like formed in the second insulating layer 55 which is another insulating layer, and the insulating layers are firmly connected to each other, thereby improving impact resistance. The same applies to the case where the through hole h of the second insulating layer is filled with the solder sd.

As described above, the coil patterns U1 to U4, V1 to V4, and W1 to W4 constitute the three phase coil pattern. The total number of these coil patterns is 12, which is an even number. The number of poles of each of the magnetic pole portions 30 and 40 is eight. Thus, the total number of coil patterns is 1.5 times the number of poles.

As another example, the total number of coil patterns may be 6, which is an even number, and the number of poles of the magnetic pole portion may be 4. In this case, the number of coil patterns of each of the U phase, the V phase, and the W phase is two. For example, three coil patterns may be provided in the first insulating layer 53 of the printed circuit board 50, and the remaining three coil patterns may be provided in the second insulating layer 55 of the printed circuit board 50. In this case, the total number of coil patterns is 1.5 times the number of poles.

As still another example, the total number of coil patterns may be 18, which is an even number, and the number of poles of the magnetic pole portion may be 6.

In this case, the number of coil patterns of each of the U phase, the V phase, and the W phase is six. For example, nine coil patterns may be provided in the first insulating layer 53 of the printed circuit board 50, and the remaining nine coil patterns may be provided in the second insulating layer 55 of the printed circuit board 50. In this case, the total number of coil patterns is three times the number of poles.

When the coil patterns are wound in a distributed manner, the position sensor is surrounded by any one of the coil patterns, and the position sensor is disposed between other two coil patterns which are spaced apart from the coil pattern in the axial direction A and adjacent to each other in the circumferential direction C, as in the above-described example, the three phase coil patterns are formed, and the total number of the coil patterns is preferably an even number and 1.5 times or 3 times the number of poles. This allows the coil pattern and the position sensor to be arranged at theoretical positions without interference. Further, 1.5 times the number of poles is preferable. This is because, when the number of poles is increased to three times the number of poles, the number of coil patterns required is increased, and the structure is complicated accordingly, which might make the manufacturing difficult.

As described above, a plurality of coil patterns are formed in the printed circuit board 50. For example, when a printed circuit board and a plurality of coils are manufactured separately and the plurality of coils are fixed to desired positions on the printed circuit board, the operation process might become complicated. In the present embodiment, each coil pattern is formed of conductive material in the printed circuit board 50 in the manufacturing process of the printed circuit board 50. Thus, the working process is simplified.

In the manufacturing process of the printed circuit board 50, circuit patterns for the position sensors P1 to P3 are also formed simultaneously with the formation of the coil patterns, and the position sensors P1 to P3 and the circuit patterns are connected to the above-described positions. This improves the relative position accuracy between each coil pattern and the position sensors P1 to P3. Therefore, the switching timing of each coil pattern based on the detection results of the position sensors P1 to P3 is also accurate, and the accuracy of rotation control is improved.

By integrally forming the first insulating layer 53 and the second insulating layer 55 in the manufacturing process of the printed circuit board 50, the relative positional accuracy between the plurality of coil patterns formed in the first insulating layer 53 and the plurality of coil patterns formed in the second insulating layer 55 is improved. This also improves the accuracy of the rotation control.

The first insulating layer 53 and the second insulating layer 55 may be formed separately, and then the first insulating layer 53 and the second insulating layer 55 may be bonded together with an adhesive or the like. This facilitates a change in the manufacturing process of the printed circuit board 50, and for example, facilitates a change in specifications.

The coil patterns U1, W1, V2, U3, W3, and V4 are formed within the first insulating layer 53, but may be formed on, for example, the end surface of the first insulating layer 53 on the side opposite to the second insulating layer 55. The coil patterns V1, U2, W2, V3, U4, and W4 are formed within the second insulating layer 55, but may be formed on, for example, the end surface of the second insulating layer 55 on the side opposite to the first insulating layer 53. The printed circuit board 50 described above includes the two first insulating layers 53 and the second insulating layer 55, but may include three or more layers.

In addition, although the description has been made to the effect that the pads pd of the first insulating layer 53 and the second insulating layer 55 are conductively connected to each other, and the pads pd are conductively connected to the power supply pattern ep, the signal pattern, the power pattern, the ground pattern, and the like, the pads pd are not necessarily required. For example, the conductive materials of the inner walls of the through holes H and the through holes h may be conductively connected to each other. The conductive material of the inner wall may be conductively connected to the power supply pattern ep or the like. The solder sd filled in the through hole H or the through hole h may be conductively connected to the conductive material of the inner wall of the through hole H or the through hole h. The solder sd filled in the through hole H or the through hole h may be conductively connected to the power supply pattern ep or the like.

While the exemplary embodiments of the present disclosure have been illustrated in detail, the present disclosure is not limited to the above-mentioned embodiments, and other embodiments, variations and variations may be made without departing from the scope of the present disclosure.

What is claimed is:

1. A stator, of an axial gap motor, comprising:
a printed circuit board having insulating layers including first and second insulating layers;
first coil patterns formed of conductor patterns in the first insulating layer; and
second coil patterns formed of conductor patterns in the second insulating layer.

2. The stator, of the axial gap motor, according to claim 1, further comprising
a first through hole formed in the first insulating layer and conductively connected to any of the first coil patterns; and
a second through hole formed in the second insulating layer, electrically connected to any of the second coil patterns, electrically connected to the first through hole, and overlapping the first through hole in a thickness direction of the printed circuit board.

3. The stator, of the axial gap motor, according to claim 2, wherein
the second through holes are formed in the second insulating layer, and
the first through hole overlaps the second through holes in the thickness direction of the printed circuit board and is conductively connected to the second through holes.

4. The stator, of the axial gap motor, according to claim 3, wherein an inner diameter of the first through hole is larger than an inner diameter of the second through hole.

5. The stator, of the axial gap motor, according to claim 4, wherein the first through hole and the second through holes are filled with a common solder.

6. The stator, of the axial gap motor, according to claim 1, further comprising:
a first through hole formed in the first insulating layer and conductively connected to any of the first coil patterns; and
a pad formed on the second insulating layer, electrically connected to a power supply pattern, electrically connected to the first through hole, and overlapping the first through hole in a thickness direction of the printed circuit board.
